(19) United States
(12) Patent Application Publication
(10) Pub. No.: US 2016/0222330 A1
(43) Pub. Date: Aug. 4, 2016

(54) DETERGENT PACK

(71) Applicant: The Procter & Gamble Company, Cincinnati, OH (US)

(72) Inventors: Nathalie Sophie LETZELTER, Trimdon (GB); Graham Peter CALVERT, Sunderland (GB); Sarah Jane MELVILLE, Newcastle upon Tyne (GB)

(21) Appl. No.: 15/008,477

(22) Filed: Jan. 28, 2016

(30) Foreign Application Priority Data
Feb. 2, 2015 (EP) 15153517.6

(51) Int. Cl. C11D 17/04; C11D 3/33; C11D 3/386; C11D 3/39

(52) U.S. Cl. CPC C11D 17/044; C11D 3/3942; C11D 3/33; C11D 3/386

(57) ABSTRACT

A moisture-permeable detergent pack comprising a plurality of water-soluble unit-dose detergent products the products comprising a phosphate-free detergent composition and an enveloping material the detergent composition comprising:
a) a moisture sensitive ingredient; and
b) from 15% to 50% by weight of the product of an aminocarboxylic complexing agent wherein the aminocarboxylic complexing agent is in the form of a hygroscopic particle.

### TECHNICAL FIELD

The present invention is in the field of detergents. In particular, it relates to a detergent pack comprising water-soluble cleaning products with improved stability.

### BACKGROUND OF THE INVENTION

Detergent products can present stability issues due to the presence of moisture sensitive ingredients such as bleach and enzymes. Some detergent products are enveloped with a wrapping of water-soluble material, the wrapping material is usually susceptible to water and permeable to moisture. In order to protect the wrapping material and the enclosed composition the products are stored in packs which reduce transfer of moisture from the environment to the interior of the product and vice-versa. However, the moisture transfer is not totally eliminated especially under stressed conditions such as high temperature and high humidity.

Traditionally, phosphate builders have been used in detergents. Environmental considerations make desirable the replacement of phosphate by more environmentally friendly builders. Apart from cleaning repercussions, the replacement of phosphate can impair the stability of the detergent. Phosphate is a good moisture sink that contributes to moisture management and stability of the detergent. The majority of the builders that can be used as replacement for phosphate are not very good acting as moisture sinks and can contribute to the chemical instability and degradation of the detergent. This has a greater impact in detergents which comprise moisture sensitive ingredients.

WO 03/047998 discloses the combination of a water-soluble capsule containing a detergent composition with a package containing the capsule. The package is formed from a material which has a moisture vapour transfer rate of between 0.25 g/m2/day to 10 g/m2/day at 38° C. and 90% relative humidity.

Aminocarboxylic complexing agents have been considered as phosphate replacement. Many attempts have been made to reduce the hygroscopicity of aminocarboxylic complexing agents (see for example EP 2380962 A).

The objective of the present invention is to provide a moisture-permeable detergent pack comprising water-soluble unit-dose detergent products with improved chemical stability.

### SUMMARY OF THE INVENTION

According to the first aspect of the invention, there is provided a detergent pack. The detergent pack is moisture permeable. A detergent pack is deemed to be moisture permeable if the empty detergent pack can equilibrate with the environment (80% relative humidity and 32° C.) in less than 12 hours.

The detergent pack comprises a plurality of water-soluble unit-dose detergent products the products comprising a detergent composition and an enveloping material.

By “unit-dose form” is herein meant that the composition is provided in a form sufficient to provide enough detergent for one wash. Suitable unit dose forms include sachets, capsules, pouches, etc. Preferred for use herein are compositions wrapped in water-soluble material made of polyvinyl alcohol. The detergent product of the invention preferably weighs from about 8 to about 25 grams, preferably from about 10 to about 20 grams. This weight range fits comfortable in a dishwasher dispenser.

The detergent composition of the pack of the invention is sometimes herein referred as “the composition of the invention”.

The composition of the invention is phosphate-free. By “phosphate-free” is herein understood that the composition comprises less than 1%, preferably less than 0.1% by weight of the composition of phosphate.

Moisture sensitive ingredients used in detergent compositions include enzymes, bleach, bleach activators, bleach catalyst, perfume, etc. In addition the water-soluble film is susceptible to changes due to moisture. Moisture can affect the mechanical and chemical properties of the film, making it stickier and less strong.

It has been found that the stability of the detergent product and in particular the chemical stability of detergent compositions is improved when the composition comprises an aminocarboxylic complexing agent in the form of a hygroscopic particle. The hygroscopic particle of the composition of the invention presents a rapid moisture pick up and at the same time it can pick up quite a lot of moisture. Without being bound by theory, it is believed that the combination of the fast moisture absorption kinetic and the high water absorption capacity contributes to the stability of the detergent composition.

The hygroscopic particle of the invention can pick up at least 1% of its weight at 32° C. and 80% relative humidity in less than 150 minutes, preferably less than 120 minutes and preferably the hygroscopic particle can pick up at least 10% of its weight at 32° C. and 80% relative humidity in less than 24 hours.

The rate of moisture intake is measure by placing the hygroscopic particles in a petri dish of 43 mm diameter and14 mm height, the petri dish is filled to reach a height of 10 mm, the weight is measured and the petri dish is placed in a chamber at 32° C. and 80% relative humidity, the samples at taken out of the chamber at fixed time intervals and weighed. The percentage mass increase is calculated based on the initial mass.

In addition to the fast kinetic the particles preferably have a high moisture absorption capacity. The hygroscopic particle can pick up at least 50%, more preferably 50% and less than 70% of its weight at 32° C. and 80% relative humidity.

The aminocarboxylic complexing agent is selected from the group consisting of methyl glycine diacetic acid, its salts and derivatives thereof, glutamic-N,N-diacetic acid, its salts and derivatives thereof and mixtures thereof. Especially preferred for use herein is the tri-sodium salt of methyl glycine diacetic acid.

Preferably, the hygroscopic particle comprises:
a) from 5 to 95% by weight of the particle of aminocarboxylic acid, preferably a salt of methyl glycine diacetic acid;
b) from 5 to 95% by weight of the particle of material selected from the group consisting of:
   i) polyalkylene glycol, preferably polyethylene glycol
   ii) nonionic surfactant;
   iii) a polymer selected from the group consisting of polyvinyl alcohols, polyvinylpyrrolidones (PVP), and
   iv) a mixture thereof.

A very suitable process for making the hygroscopic particle comprises the steps of dissolving components (a) and (b) in a solvent and spray-drying the resulting mixture and optionally followed by a granulation step.

Preferably the hygroscopic particle has a weight geometric mean particle size of from about 700 to about 1000 μm with less than about 3% by weight above about 1180 μm and less than about 5% by weight below about 200 μm.

Preferably the particle has a bulk density of at least 550 g/l, more preferably from about 600 to about 1,400 g/l, even more preferably from about 700 g/l to about 1,200 g/l. This makes the particle suitable for use in detergent compositions, especially automatic dishwashing detergent compositions.

Preferably, the composition of the invention is alkaline, by “alkaline” is herein meant that the pH of the composition is greater than 7, preferably greater than 9 as measured in 1% weight aqueous solution in distilled water at 20° C. Alkaline composition can be more prone to chemical instability caused by moisture.

The composition of the invention comprises bleach and enzymes, preferably amylase and protease. Stability is improved when MGDA is present in the same compartment as the bleach and the enzymes.

The cleaning composition preferably comprises a particulate composition. The particulate composition is preferably in the form of loose powder. By “loose-powder” is herein meant a powder comprising a plurality of independent particles, i.e., the particles are not bound to one another. When the loose powder is delivered into the dishwasher the particles in the wash liquor are found as individual entities rather than in the form of a single entity constituted by a plurality of particles. The particulate loose-powder can be enveloped by a water-soluble wrapping or encasing material such as a water-soluble film or an injection-moulded container. Particulate loose-powder wrapped in water-soluble material is considered “loose powder” for the purpose of the invention because once the enveloping water-soluble material is dissolved the particles are found in the wash liquor as individual entities. Pressed tablets are not considered a product comprising a particulate loose powder composition.

According to a second aspect of the invention, there is provided the use of a hygroscopic particle comprising an aminocarboxylic complexing agent, preferably the tri-sodium salt of methyl glycine diacetic acid, to improve the chemical stability of a phosphate-free automatic dishwashing detergent composition. During the course of the work leading to this invention, it was surprisingly found that a composition comprising the hygroscopic particle is more chemically stable than a composition comprising high level of phosphate.

The elements of the composition of the invention described in connection with the first aspect of the invention apply mutatis mutandis to the second aspect of the invention.

### SUMMARY OF THE INVENTION

The present invention encompasses a moisture-permeable detergent pack. The detergent pack comprises a plurality of water-soluble unit-dose detergent products. The products comprise a moisture permeable enveloping material (preferably a polyvinyl alcohol film) and a moisture sensitive ingredient. The composition is phosphate free and comprises a hygroscopic particle comprising an aminocarboxylic agent. The product present improved chemical stability even at stressed conditions (such as 32° C. and 80% relative humidity)

### Moisture-Permeable Detergent Pack

The detergent pack can be a tub, tray, jar, bottle, bag, box, etc, preferably the is reclosable. Preferably the pack is a reclosable flexible bag, preferably self-standing.

By “flexible” bag is understood a bag which can be easily deformed with a hand squeeze, preferably deformed by the mere act of holding the bag.

### Water-Soluble Unit-Dose Detergent Products

The composition of the invention is presented in unit-dose form. Products in unit dose form include capsules, sachets, pouches, injection moulded containers, etc. Preferred packs are pouches, where the detergent composition is enveloped by a water-soluble film, and injection moulded containers wherein the detergent composition is placed in a container of water-soluble material made by injection moulding. Both the detergent composition and the enveloping material are water-soluble. They readily dissolve when exposed to water in an automatic dishwashing process, preferably during the main wash. The detergent products can have a single compartment or a plurality of compartments. The compartments can comprise a composition in liquid or solid form. Preferably the composition of the invention or part thereof is in particulate form and enveloped by a polyvinyl alcohol film of less than 100 μm.

Preferably, the unit dose detergent can by in the form of a multi-compartment pouch or injection moulded container. By “multi-compartment” is herein meant a pouch or injection moulded container having at least two compartments, preferably at least three compartments, each compartment contains a composition surrounded by enveloping material, preferably polyvinyl alcohol. The compartments can be in any geometrical disposition. The different compartments can be adjacent to one another, preferably in contact with one another. Especially preferred configurations for use herein include superposed compartments (i.e. one above the other), side-by-side compartments, etc. Especially preferred from a view point of automatic dishwasher dispenser fit, stability and enveloping material reduction are multi-compartment pouches or containers having some superposed compartments and/or some side-by-side compartments.

### Enveloping Material

The enveloping material is water soluble. By “water-soluble” is herein meant that the material has a water-solubility of at least 50%, preferably at least 75% or even at least 95%, as measured by the method set out herein after using a glass-filter with a maximum pore size of 20 microns.

50 grams±0.1 gram of enveloping material is added in a pre-weighed 400 ml beaker and 245 ml±1 ml of distilled water is added. This is stirred vigorously on a magnetic stirrer set at 600 rpm, for 30 minutes at 20° C. Then, the mixture is filtered through a folded qualitative sintered-glass filter with a pore size as defined above (max, 20 micron). The water is dried off from the collected filtrate by any conventional method, and the weight of the remaining material is determined (which is the dissolved or dispersed faction). Then, the % solubility can be calculated.

The enveloping material is any water-soluble material capable of enclosing the cleaning composition of the product of the invention. The enveloping material can be a polymer that has been injection moulded to provide a casing or it can be a film. Preferably the enveloping material is made of polyvinyl alcohol. Preferably the enveloping material is a water-soluble polyvinyl alcohol film.

The pouch can, for example, be obtained by injection moulding or by creating compartments using a film. The enveloping material is usually moisture permeable. The pouch of the invention is stable even when the enveloping material is moisture permeable. The liquid composition confers stability to the pouch, in terms of both interaction among the different compositions and interaction with the surrounding environment.

Preferred substances for making the enveloping material include polymers, copolymers or derivatives thereof selected from polyvinyl alcohols, polyvinyl pyrrolidone, polyalkylene oxides, acrylamide, acrylic acid, cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides including starch and gelatine, natural gums such as xanthum and carragum. More preferred polymers are selected from polyacrylates and water-soluble acrylate copolymers, methylcellulose, carboxymethylcellulose sodium, dextrin, ethylcellulose, hydroxyethyl cellulose, hydroxypropyl methylcellulose, maltodextrin, polymethacrylates, and most preferably selected from polyvinyl alcohols, polyvinyl alcohol copolymers and hydroxypropyl methyl cellulose (HPMC), and combinations thereof. Especially preferred for use herein is polyvinyl alcohol and even more preferred polyvinyl alcohol films.

Most preferred enveloping materials are PVA films known under the trade reference Monosol M8630, as sold by Kuraray, and PVA films of corresponding solubility and deformability characteristics. Other films suitable for use herein include films known under the trade reference PT film or the K-series of films supplied by Aicello, or VF-HP film supplied by Kuraray.

The enveloping material herein may comprise other additive ingredients than the polymer or polymer material and water. For example, it may be beneficial to add plasticisers, for example glycerol, ethylene glycol, diethyleneglycol, propylene glycol, dipropylene glycol, sorbitol and mixtures thereof. Preferably the enveloping material comprises glycerol as plasticisers. Other useful additives include disintegrating aids.

### Hygroscopic Particle

Preferably, the hygroscopic particle comprises:
a) from 20 to 95%, more preferable from 40 to 60% by weight of the particle of aminocarboxylic acid, preferably a salt of methyl glycine diacetic acid, more preferably the tri-sodium salt;
b) from 5 to 80% by weight of the particle of material selected from the group consisting of:
   i) polyalkylene glycol, preferably polyethylene glycol
   ii) nonionic surfactant;
   iii) a polymer selected from the group consisting of polyvinyl alcohols, polyvinylpyrrolidones (PVP), and
   iv) a mixture thereof.

Preferred polyethylene glycols in component (b) have an average molecular weight (weight-average molecular weight) of from 500 to 30,000 g/mol, more preferably of from 1000 to 5000 g/mol, most preferably from 1200 to 2000 g/mol.

Nonionic surfactants in component (b) are preferably selected from the group consisting of alkoxylated primary alcohols, alkoxylated fatty alcohols, alkylglycosides, alkoxylated fatty acid alkyl esters, amine oxides and polyhydroxy fatty acid amides. Preferably the nonionic surfactant in component (b) has a melting point of above 20° C.

The hygroscopic particle may be produced by dissolving components (a) and (b) in a solvent and spray-drying the resulting mixture, which may be followed by a granulation step. In this process, components (a) and (b) may be dissolved separately, in which case the solutions are subsequently mixed, or a powder mixture of the components may be dissolved in water. Useful solvents are all of those which can dissolve components (a) and (b); preference is given to using, for example, alcohols and/or water, particular preference to using water. Spray-drying is preferably followed by a granulation step.

### Detergent Composition

The detergent composition of the invention is presented in unit-dose form and it can be in any physical form including solid, liquid and gel form. The composition of the invention is very well suited to be presented in the form of a multi-compartment pack, more in particular a multi-compartment pack comprising compartments with compositions in different physical forms, for example a compartment comprising a composition in solid form and another compartment comprising a composition in liquid form. The composition is preferably enveloped by a water-soluble film such as polyvinyl alcohol. The composition comprises a hygroscopic particle comprising an aminocarboxylic complexing agent, preferably the tri-sodium salt of MGDA, preferably a sulfonated polymer comprising 2-acrylamido-2-methylpropane sulfonic acid monomers, a bleach, preferably sodium percarbonate and preferably an inorganic builder, more preferably carbonate, a bleach activator, a bleach catalyst, protease and amylase enzymes, non-ionic surfactant, a crystal growth inhibitor, more preferably HEDP. The composition is preferably free of citrate.

The composition of the invention preferably has a pH as measured in 1% weight/volume aqueous solution in distilled water at 20° C. of from about 9 to about 12, more preferably from about 10 to less than about 11.5 and especially from about 10.5 to about 11.5.

The composition of the invention preferably has a reserve alkalinity of from about 10 to about 20, more preferably from about 12 to about 18 at a pH of 9.5 as measured in NaOH with 100 grams of product at 20° C.

### Aminocarboxylic Complexing Agent

A complexing agent is a material capable of sequestering hardness ions, particularly calcium and/or magnesium.

The composition of the invention comprises from 5% to 50% of complexing agent, preferably from 10 to 40% by weight of the composition. The complexing agent is preferably selected from the group consisting of methyl-glycine-diacetic acid, its salts and derivatives thereof, glutamic-N,N-diacetic acid, its salts and derivatives thereof, and mixtures thereof. Especially preferred complexing agent for use herein is a salt of MGDA, in particular the tri-sodium salt of MGDA.

### Dispersant Polymer

The polymer, if present, is used in any suitable amount from about 0.1% to about 30%, preferably from 0.5% to about 20%, more preferably from 1% to 10% by weight of the composition. Preferably the dispersant polymer is a sulfonated polymer, more preferably a sulfonated polymer comprising 2-acrylamido-2-methylpropane sulfonic acid monomers and carboxyl monomers.

### Polycarboxylate Polymer

For example, a wide variety of modified or unmodified polyacrylates, polyacrylate/maleates, or polyacrylate/methacrylates are highly useful. It is believed these polymers are excellent dispersing agents and enhance overall detergent performance, particularly when used in the composition of the invention.

Suitable polycarboxylate-based polymers include polycarboxylate polymers that may have average molecular weights of from about 500 Da to about 500,000 Da, or from about 1,000 Da to about 100,000 Da, or even from about 3,000 Da to about 80,000 Da. Suitable polycarboxylates may be selected from the group comprising polymers comprising acrylic acid such as Sokalan PA30, PA20, PA15, PA10 and sokalan CP10 (BASF GmbH, Ludwigshafen, Germany), Acusol™ 45N, 480N, 460N and 820 (sold by Rohm and Haas, Philadelphia, Pa., USA) polyacrylic acids, such as Acusol™ 445 and Acusol™ 420 (sold by Rohm and Haas, Philadelphia, Pa., USA) acrylic/maleic co-polymers, such as Acusol™ 425N and acrylic/methacrylic copolymers.

Alkoxylated polycarboxylates such as those prepared from polyacrylates are useful herein to and can provide additional grease suspension. Chemically, these materials comprise polyacrylates having one ethoxy side-chain per every 7-8 acrylate units. The side-chains are ester-linked to the polyacrylate “backbone” to provide a “comb” polymer type structure. The molecular weight can vary, but may be in the range of about 2000 to about 50,000.

Unsaturated monomeric acids that can be polymerized to form suitable dispersing polymers include acrylic acid, maleic acid (or maleic anhydride), fumaric acid, itaconic acid, aconitic acid, mesaconic acid, citraconic acid and methylenemalonic acid. The presence of monomeric segments containing no carboxylate radicals such as methyl vinyl ether, styrene, ethylene, etc. is suitable provided that such segments do not constitute more than about 50% by weight of the dispersant polymer.

Co-polymers of acrylamide and acrylate having a molecular weight of from about 3,000 to about 100,000, preferably from about 4,000 to about 20,000, and an acrylamide content of less than about 50%, preferably less than about 20%, by weight of the dispersant polymer can also be used. Most preferably, such dispersant polymer has a molecular weight of from about 4,000 to about 20,000 and an acrylamide content of from about 0% to about 15%, by weight of the polymer.

### Sulfonated Polymers

Suitable sulfonated polymers described herein may have a weight average molecular weight of less than or equal to about 100,000 Da, preferably less than or equal to about 75,000 Da, more preferably less than or equal to about 50,000 Da, more preferably from about 3,000 Da to about 50,000, and specially from about 5,000 Da to about 45,000 Da.

The sulfonated polymers preferably comprises carboxylic acid monomers and sulfonated monomers. Preferred carboxylic acid monomers include one or more of the following: acrylic acid, maleic acid, itaconic acid, methacrylic acid, or ethoxylate esters of acrylic acids, acrylic and methacrylic acids being more preferred. Preferred sulfonated monomers include one or more of the following: sodium (meth) allyl sulfonate, vinyl sulfonate, sodium phenyl (meth) allyl ether sulfonate, or 2-acrylamido-methyl propane sulfonic acid. Preferred non-ionic monomers include one or more of the following: methyl (meth) acrylate, ethyl (meth) acrylate, t-butyl (meth) acrylate, methyl (meth) acrylamide, ethyl (meth) acrylamide, t-butyl (meth) acrylamide, styrene, or a-methyl styrene.

Specially preferred sulfonated polymers for use herein are those comprising monomers of acrylic acid and monomers of 2-acrylamido-methyl propane sulfonic acid.

In the polymers, all or some of the carboxylic or sulfonic acid groups can be present in neutralized form, i.e. the acidic hydrogen atom of the carboxylic and/or sulfonic acid group in some or all acid groups can be replaced with metal ions, preferably alkali metal ions and in particular with sodium ions.

Preferred commercial available polymers include: Alcosperse 240, Aquatreat AR 540 and Aquatreat MPS supplied by Alco Chemical; Acumer 3100, Acumer 2000, Acusol 587G and Acusol 588G supplied by Rohm & Haas; Goodrich K-798, K-775 and K-797 supplied by BF Goodrich; and ACP 1042 supplied by ISP technologies Inc. Particularly preferred polymers are Acusol 587G and Acusol 588G supplied by Rohm & Haas, Versaflex Si™ (sold by Alco Chemical, Tenn., USA) and those described in U.S. Pat. No. 5,308,532 and in WO 2005/090541.

Suitable styrene co-polymers may be selected from the group comprising, styrene co-polymers with acrylic acid and optionally sulphonate groups, having average molecular weights in the range 1,000-50,000, or even 2,000-10,000 such as those supplied by Alco Chemical Tenn., USA, under the tradenames Alcosperse® 729 and 747.

Other dispersant polymers useful herein include the cellulose sulfate esters such as cellulose acetate sulfate, cellulose sulfate, hydroxyethyl cellulose sulfate, methylcellulose sulfate, and hydroxypropylcellulose sulfate. Sodium cellulose sulfate is the most preferred polymer of this group.

Other suitable dispersant polymers are the carboxylated polysaccharides, particularly starches, celluloses and alginates. Preferred cellulose-derived dispersant polymers are the carboxymethyl celluloses.

Yet another group of acceptable dispersing agents are the organic dispersing polymers, such as polyaspartates.

Amphilic graft co-polymer are useful for use herein. Suitable amphilic graft co-polymer comprises (i) polyethylene glycol backbone; and (ii) and at least one pendant moiety selected from polyvinyl acetate, polyvinyl alcohol and mixtures thereof. In other examples, the amphilic graft copolymer is Sokalan HP22, supplied from BASF.

### Bleach

The composition of the invention preferably comprises from about 1 to about 20%, more preferably from about 2 to about 15%, even more preferably from about 3 to about 12% and especially from about 4 to about 10% by weight of the composition.

Inorganic and organic bleaches are suitable for use herein. Inorganic bleaches include perhydrate salts such as perborate, percarbonate, perphosphate, persulfate and persilicate salts. The inorganic perhydrate salts are normally the alkali metal salts. The inorganic perhydrate salt may be included as the crystalline solid without additional protection. Alternatively, the salt can be coated. Suitable coatings include sodium sulphate, sodium carbonate, sodium silicate and mixtures thereof. Said coatings can be applied as a mixture applied to the surface or sequentially in layers.

Alkali metal percarbonates, particularly sodium percarbonate is the preferred bleach for use herein. The percarbonate is most preferably incorporated into the products in a coated form which provides in-product stability.

Potassium peroxymonopersulfate is another inorganic perhydrate salt of utility herein.

Typical organic bleaches are organic peroxyacids, especially diperoxydodecanedioc acid, diperoxytetradecanedioc acid, and diperoxyhexadecanedioc acid. Mono- and diperazelaic acid, mono- and diperbrassylic acid are also suitable herein. Diacyl and Tetraacylperoxides, for instance dibenzoyl peroxide and dilauroyl peroxide, are other organic peroxides that can be used in the context of this invention.

Further typical organic bleaches include the peroxyacids, particular examples being the alkylperoxy acids and the arylperoxy acids. Preferred representatives are (a) peroxybenzoic acid and its ring-substituted derivatives, such as alkylperoxybenzoic acids, but also peroxy-α-naphthoic acid and magnesium monoperphthalate, (b) the aliphatic or substituted aliphatic peroxy acids, such as peroxylauric acid, peroxystearic acid, ε-phthalimidoperoxycaproic acid[phthaloiminoperoxyhexanoic acid (PAP)], o-carboxybenzamidoperoxycaproic acid, N-nonenylamidoperadipic acid and N-nonenylamidopersuccinates, and (c) aliphatic and araliphatic peroxydicarboxylic acids, such as 1,12-diperoxycarboxylic acid, 1,9-diperoxyazelaic acid, diperoxysebacic acid, diperoxybrassylic acid, the diperoxyphthalic acids, 2-decyldiperoxybutane-1,4-dioic acid, N,N-terephthaloyldi(6-aminopercaproic acid).

### Bleach Activators

Bleach activators are typically organic peracid precursors that enhance the bleaching action in the course of cleaning at temperatures of 60° C. and below. Bleach activators suitable for use herein include compounds which, under perhydrolysis conditions, give aliphatic peroxoycarboxylic acids having preferably from 1 to 12 carbon atoms, in particular from 2 to 10 carbon atoms, and/or optionally substituted perbenzoic acid. Suitable substances bear O-acyl and/or N-acyl groups of the number of carbon atoms specified and/or optionally substituted benzoyl groups. Preference is given to polyacylated alkylenediamines, in particular tetraacetylethylenediamine (TAED), acylated triazine derivatives, in particular 1,5-diacetyl-2,4-dioxohexahydro-1,3,5-triazine (DADHT), acylated glycolurils, in particular tetraacetylglycoluril (TAGU), N-acylimides, in particular N-nonanoylsuccinimide (NOSI), acylated phenolsulfonates, in particular n-nonanoyl- or isononanoyloxybenzenesulfonate (n- or iso-NOBS), decanoyloxybenzoic acid (DOBA), carboxylic anhydrides, in particular phthalic anhydride, acylated polyhydric alcohols, in particular triacetin, ethylene glycol diacetate and 2,5-diacetoxy-2,5-dihydrofuran and also triethylacetyl citrate (TEAC). If present the composition of the invention comprises from 0.01 to 1, preferably from 0.2 to 0.5% by weight of the composition of bleach activator, preferably TAED.

### Bleach Catalyst

The composition herein preferably contains a bleach catalyst, preferably a metal containing bleach catalyst. More preferably the metal containing bleach catalyst is a transition metal containing bleach catalyst, especially a manganese or cobalt-containing bleach catalyst. Bleach catalysts preferred for use herein include manganese triazacyclononane and related complexes; Co, Cu, Mn and Fe bispyridylamine and related complexes; and pentamine acetate cobalt(III) and related complexes. A complete description of bleach catalysts suitable for use herein can be found in WO 99/06521, pages 34, line 26 to page 40, line 16.

Manganese bleach catalysts are preferred for use in the composition of the invention. Especially preferred catalyst for use here is a dinuclear manganese-complex having the general formula:

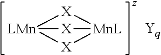

wherein Mn is manganese which can individually be in the III or IV oxidation state; each x represents a coordinating or bridging species selected from the group consisting of H2O, O22-, O2-, OH—, HO2-, SH—, S2-, >SO, N3-, SCN—, RCOO—, NH2- and NR3, with R being H, alkyl or aryl, (optionally substituted); L is a ligand which is an organic molecule containing a number of nitrogen atoms which coordinates via all or some of its nitrogen atoms to the manganese centres; z denotes the charge of the complex and is an integer which can be positive or negative; Y is a monovalent or multivalent counter-ion, leading to charge neutrality, which is dependent upon the charge z of the complex; and q=z/[charge Y]

Preferred manganese-complexes are those wherein x is either CH₃COO⁻ or O² or mixtures thereof, most preferably wherein the manganese is in the IV oxidation state and x is O²⁻. Preferred ligands are those which coordinate via three nitrogen atoms to one of the manganese centres, preferably being of a macrocyclic nature. Particularly preferred ligands are:

1,4,7-trimethyl-1,4,7-triazacyclononane, (Me-TACN); and (1)

1,2,4,7-tetramethyl-1,4,7-triazacyclononane, (Me-Me TACN). (2)

The type of counter-ion Y for charge neutrality is not critical for the activity of the complex and can be selected from, for example, any of the following counter-ions: chloride; sulphate; nitrate; methylsulphate; surfactant anions, such as the long-chain alkylsulphates, alkylsulphonates, alkylbenzenesulphonates, tosylate, trifluoromethylsulphonate, perchlorate (ClO₄⁻), BPh₄⁻, and PF₆⁻, though some counter-ions are more preferred than others for reasons of product property and safety.

Consequently, the preferred manganese complexes useable in the present invention are:

[(Me-TACN)Mn^{IV}(Âμ-0)₃Mn^{IV}(Me-TACN)]²⁺(PF₆⁻)₂ (I)

[(Me-MeTACN)Mn^{IV}(Âμ-0)₃Mn^{IV}(Me-MeTACN)]²⁺(PF₆⁻)₂ (II)

[(Me-TACN)Mn^{III}(Âμ-0)(Âμ-OAc)₂Mn^{III}(Me-TACN)]^{2±}(PF₆⁻)₂ (III)

[(Me-MeTACN)Mn^{III}(Âμ-0)(Âμ-OAc)₂Mn^{III}(Me-MeTACN)]²⁺(PF₆⁻)₂ (IV)

which hereinafter may also be abbreviated as:

[Mn^{IV}₂(Âμ-0)₃(Me-TACN)₂](PF₆)₂ (I)

[Mn^{IV}₂(Âμ-0)₃(Me-MeTACN)₂](PF₆)₂ (II)

[Mn^{III}₂(Âμ-0) (Âμ-OAc)₂(Me-TACN)₂](PF₆)₂ (III)

[Mn^{III}₂(Âμ-0) (Âμ-OAc)₂(Me-TACN)₂](PF₆)₂ (IV)

The structure of I is given below:

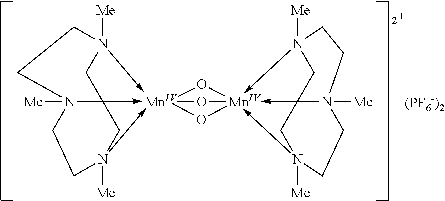

abbreviated as [Mn^{IV}₂(Âμ-0)₃(Me-TACN)₂](PF₆)₂.

The structure of II is given below:

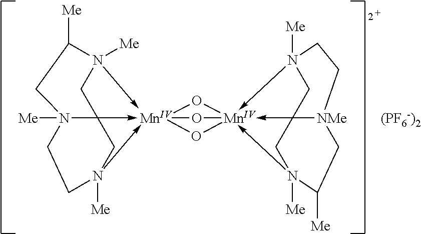

abbreviated as [Mn^{IV}₂(Âμ-0)₃(Me-MeTACN)₂](PF₆)₂.

It is of note that the manganese complexes are also disclosed in EP-A-0458397 and EP-A-0458398 as unusually effective bleach and oxidation catalysts. In the further description of this invention they will also be simply referred to as the “catalyst”.

Preferably the composition of the invention comprises from 0.001 to 0.5, more preferably from 0.002 to 0.05% of bleach catalyst by weight of the composition. Preferably the bleach catalyst is a manganese bleach catalyst.

### Inorganic Builder

The composition of the method of the invention preferably comprises an inorganic builder. Suitable inorganic builders are selected from the group consisting of carbonate, silicate and mixtures thereof. Especially preferred for use herein is sodium carbonate. Preferably the product of the method of the invention comprises from 5 to 50%, more preferably from 10 to 40% and especially from 15 to 30% of sodium carbonate by weight of the product.

### Surfactant

Surfactants suitable for use herein include non-ionic surfactants, preferably the compositions are free of any other surfactants. Traditionally, non-ionic surfactants have been used in automatic dishwashing for surface modification purposes in particular for sheeting to avoid filming and spotting and to improve shine. It has been found that non-ionic surfactants can also contribute to prevent redeposition of soils.

Preferably the composition of the invention comprises a non-ionic surfactant or a non-ionic surfactant system, more preferably the non-ionic surfactant or a non-ionic surfactant system has a phase inversion temperature, as measured at a concentration of 1% in distilled water, between 40 and 70° C., preferably between 45 and 65° C. By a “non-ionic surfactant system” is meant herein a mixture of two or more non-ionic surfactants. Preferred for use herein are non-ionic surfactant systems. They seem to have improved cleaning and finishing properties and better stability in product than single non-ionic surfactants.

Phase inversion temperature is the temperature below which a surfactant, or a mixture thereof, partitions preferentially into the water phase as oil-swollen micelles and above which it partitions preferentially into the oil phase as water swollen inverted micelles. Phase inversion temperature can be determined visually by identifying at which temperature cloudiness occurs.

The phase inversion temperature of a non-ionic surfactant or system can be determined as follows: a solution containing 1% of the corresponding surfactant or mixture by weight of the solution in distilled water is prepared. The solution is stirred gently before phase inversion temperature analysis to ensure that the process occurs in chemical equilibrium. The phase inversion temperature is taken in a thermostable bath by immersing the solutions in 75 mm sealed glass test tube. To ensure the absence of leakage, the test tube is weighed before and after phase inversion temperature measurement. The temperature is gradually increased at a rate of less than 1° C. per minute, until the temperature reaches a few degrees below the pre-estimated phase inversion temperature. Phase inversion temperature is determined visually at the first sign of turbidity.

Suitable nonionic surfactants include: i) ethoxylated non-ionic surfactants prepared by the reaction of a monohydroxy alkanol or alkyphenol with 6 to 20 carbon atoms with preferably at least 12 moles particularly preferred at least 16 moles, and still more preferred at least 20 moles of ethylene oxide per mole of alcohol or alkylphenol; ii) alcohol alkoxylated surfactants having a from 6 to 20 carbon atoms and at least one ethoxy and propoxy group. Preferred for use herein are mixtures of surfactants i) and ii).

Another suitable non-ionic surfactants are epoxy-capped poly(oxyalkylated) alcohols represented by the formula:

R1O[CH2CH(CH3)O]x[CH2CH2O]y[CH2CH(OH)R2] (I)

wherein R1 is a linear or branched, aliphatic hydrocarbon radical having from 4 to 18 carbon atoms; R2 is a linear or branched aliphatic hydrocarbon radical having from 2 to 26 carbon atoms; x is an integer having an average value of from 0.5 to 1.5, more preferably about 1; and y is an integer having a value of at least 15, more preferably at least 20.

Preferably, the surfactant of formula I, at least about 10 carbon atoms in the terminal epoxide unit [CH2CH(OH)R2]. Suitable surfactants of formula I, according to the present invention, are Olin Corporation's POLY-TERGENT® SLF-18B nonionic surfactants, as described, for example, in WO 94/22800, published Oct. 13, 1994 by Olin Corporation.

Amine oxides surfactants are useful for use in the composition of the invention. Preferred are C10-C18 alkyl dimethylamine oxide, and C10-18 acylamido alkyl dimethylamine oxide.

Amine oxide surfactants may be present in amounts from 0 to 15% by weight, preferably from 0.1% to 10%, and most preferably from 0.25% to 5% by weight of the composition.

### Enzymes

In describing enzyme variants herein, the following nomenclature is used for ease of reference: Original amino acid(s):position(s):substituted amino acid(s). Standard enzyme IUPAC 1-letter codes for amino acids are used.

### Proteases

Suitable proteases include metalloproteases and serine proteases, including neutral or alkaline microbial serine proteases, such as subtilisins (EC 3.4.21.62) as well as chemically or genetically modified mutants thereof. Suitable proteases include subtilisins (EC 3.4.21.62), including those derived from Bacillus, such as Bacillus lentus, B. alkalophilus, B. subtilis, B. amyloliquefaciens, Bacillus pumilus and Bacillus gibsonii.

Especially preferred proteases for the detergent of the invention are polypeptides demonstrating at least 90%, preferably at least 95%, more preferably at least 98%, even more preferably at least 99% and especially 100% identity with the wild-type enzyme from Bacillus lentus, comprising mutations in one or more, preferably two or more and more preferably three or more of the following positions, using the BPN′ numbering system and amino acid abbreviations as illustrated in WO00/37627, which is incorporated herein by reference: V68A, N87S, S99D, S99SD, S99A, S101G, S101M, S103A, V104N/I, G118V, G118R, S128L, P129Q, 5130A, Y167A, R1705, A194P, V2051 and/or M222S.

Most preferably the protease is selected from the group comprising the below mutations (BPN′ numbering system) versus either the PB92 wild-type (SEQ ID NO:2 in WO 08/010925) or the subtilisin 309 wild-type (sequence as per PB92 backbone, except comprising a natural variation of N87S).

G118V+S128L+P129Q+5130A (i)

S101M+G118V+S128L+P129Q+S130A (ii)

N76D+N87R+G118R+S128L+P129Q+5130A+S188D+N248R (iii)

N76D+N87R+G118R+S128L+P129Q+5130A+S188D+V244R (iv)

N76D+N87R+G118R+S128L+P129Q+S130A (v)

V68A+N87S+S101G+V104N (vi)

Suitable commercially available protease enzymes include those sold under the trade names Savinase®, Polarzyme®, Kannase®, Ovozyme®, Everlase® and Esperase® by Novozymes A/S (Denmark), those sold under the tradename Properase®, Purafect®, Purafect Prime®, Purafect Ox®, FN3® , FN4®, Excellase®, Ultimase® and Purafect OXP® by Genencor International, those sold under the tradename Opticlean® and Optimase® by Solvay Enzymes, those available from Henkel/ Kemira, namely BLAP.

Preferred levels of protease in the product of the invention include from about 0.1 to about 10, more preferably from about 0.5 to about 7 and especially from about 1 to about 6 mg of active protease.

### Amylases

Preferred enzyme for use herein includes alpha-amylases, including those of bacterial or fungal origin. Chemically or genetically modified mutants (variants) are included. A preferred alkaline alpha-amylase is derived from a strain of Bacillus, such as Bacillus licheniformis, Bacillus amyloliquefaciens, Bacillus stearothermophilus, Bacillus subtilis, or other Bacillus sp., such as Bacillus sp. NCIB 12289, NCIB 12512, NCIB 12513, DSM 9375 (U.S. Pat. No. 7,153,818) DSM 12368, DSMZ no. 12649, KSM AP1378 (WO 97/00324), KSM K36 or KSM K38 (EP 1,022,334). Preferred amylases include:

(a) the variants described in US 5,856,164 and W099/23211, WO 96/23873, WO00/60060 and WO 06/002643, especially the variants with one or more substitutions in the following positions versus the AA560 enzyme listed as SEQ ID No. 12 in WO 06/002643:

9, 26, 30, 33, 82, 37, 106, 118, 128, 133, 149, 150, 160, 178, 182, 186, 193, 195, 202, 214, 231, 256, 257, 258, 269, 270, 272, 283, 295, 296, 298, 299, 303, 304, 305, 311, 314, 315, 318, 319, 320, 323, 339, 345, 361, 378, 383, 419, 421, 437, 441, 444, 445, 446, 447, 450, 458, 461, 471, 482, 484, preferably that also contain the deletions of D183* and G184*. (b) variants exhibiting at least 95% identity with the wild-type enzyme from Bacillus sp. 707 (SEQ ID NO:7 in U.S. Pat. No. 6,093, 562), especially those comprising one or more of the following mutations M202, M208, 5255, R172, and/or M261. Preferably said amylase comprises one of M202L or M202T mutations.

Suitable commercially available alpha-amylases include DURAMYL®, LIQUEZYME®, TERMAMYL®, TERMAMYL ULTRA®, NATALASE®, SUPRAMYL®, STAINZYME®, STAINZYME PLUS®, POWERASE®, FUNGAMYL® and BAN® (Novozymes A/S, Bagsvaerd, Denmark), KEMZYM® AT 9000 Biozym Biotech Trading GmbH Wehlistrasse 27b A-1200 Wien Austria, RAPIDASE® , PURASTAR®, ENZYSIZE®, OPTISIZE HT PLUS® and PURASTAR OXAM® (Genencor International Inc., Palo Alto, California) and KAM® (Kao, 14-10 Nihonbashi Kayabacho, 1-chome, Chuo-ku Tokyo 103-8210, Japan). Amylases especially preferred for use herein include NATALASE®, STAINZYME®, STAINZYME PLUS®, POWERASE® and mixtures thereof.

Preferably, the product of the invention comprises at least 0.01 mg, preferably from about 0.05 to about 10, more preferably from about 0.1 to about 6, especially from about 0.2 to about 5 mg of active amylase.

### Additional Enzymes

Additional enzymes suitable for use in the product of the invention can comprise one or more enzymes selected from the group comprising hemicellulases, cellulases, cellobiose dehydrogenases, peroxidases, proteases, xylanases, lipases, phospholipases, esterases, cutinases, pectinases, mannanases, pectate lyases, keratinases, reductases, oxidases, phenoloxidases, lipoxygenases, ligninases, pullulanases, tannases, pentosanases, malanases, B-glucanases, arabinosidases, hyaluronidase, chondroitinase, laccase, amylases, and mixtures thereof.

Preferably, the protease and/or amylase of the product of the invention are in the form of granulates, the granulates comprise less than 29% of sodium sulfate by weight of the granulate or the sodium sulfate and the active enzyme (protease and/or amylase) are in a weight ratio of less than 4:1.

### Crystal Growth Inhibitor

Crystal growth inhibitors are materials that can bind to calcium carbonate crystals and prevent further growth of species such as aragonite and calcite.

Especially preferred crystal growth inhibitor for use herein is HEDP (1-hydroxyethylidene 1,1-diphosphonic acid). Preferably, the composition of the invention comprises from 0.01 to 5%, more preferably from 0.05 to 3% and especially from 0.5 to 2% of a crystal growth inhibitor by weight of the product, preferably HEDP.

### Metal Care Agents

Metal care agents may prevent or reduce the tarnishing, corrosion or oxidation of metals, including aluminium, stainless steel and non-ferrous metals, such as silver and copper. Preferably the composition of the invention comprises from 0.1 to 5%, more preferably from 0.2 to 4% and especially from 0.3 to 3% by weight of the product of a metal care agent, preferably the metal care agent is benzo triazole (BTA).

### Glass Care Agents

Glass care agents protect the appearance of glass items during the dishwashing process. Preferably the composition of the invention comprises from 0.1 to 5%, more preferably from 0.2 to 4% and specially from 0.3 to 3% by weight of the composition of a metal care agent, preferably the glass care agent is a zinc containing material, specially hydrozincite.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”

### EXAMPLES

Two sets of dual-compartment automatic dishwashing pouches were made comprising the ingredients detailed herein below (Composition 1 (comparative) and Composition 2 (according to the invention)). The pouches were made of polyvinyl alcohol (Monosol M8630 supplied by Kuraray) with the solid and liquid components in different compartments.

| Ingredients (grams of active | | |
|---|---|---|
| material) | Composition 1 | Composition 2 |
| Solid compartment | | |
| Sodium Tripolyphosphate | 9.00 | — |
| Sodium carbonate | 3.02 | 4.00 |
| MGDA | — | 5.00 |
| Sodium percarbonate | 1.87 | 2.00 |
| TAED | 0.60 | — |
| Acusol 588 | 1.30 | 1.20 |
| HEDP | 0.19 | 0.10 |
| Plurafac SLF-180 | 0.10 | 0.10 |
| Protease | 0.034 | 0.034 |
| Amylase | 0.003 | 0.004 |
| Bleach catalyst | 0.002 | 0.004 |
| Miscellaneous | balance to 17.00 | balance to 14.84 |
| Liquid compartment | | |
| Lutensol TO7 | 0.89 | 0.89 |
| Plurafac SLF-180 | 0.74 | 0.74 |
| Miscellaneous | balance to 2.19 | balance to 2.19 |

MGDA Tri-sodium salt of methyl glycine diacetic acid in the form of a hygroscopic particle, Trilon M SG available from BASF
TAED Tetraacetylethylenediamine
Acusol 588 Sulphonated polycarboxylate supplied by Rohm & Haas
HEDP Sodium 1-hydroxyethylidene-1,1-diphosphonic acid
Plurafac SLF-180 Nonionic surfactant supplied by BASF
Protease Ultimase ® available from DuPont.
Amylase Stainzyme plus ® available from Novozymes
Lutensol TO7 Nonionic surfactant supplied by BASF

### Chemical Stability Data

A storage stability test was carried out. The product was stored at 32° C. and 80% relative humidity. The enzyme activity in the product was measured and compared to the initial activity after 4, 8 and 12 weeks of storage.

Six bags with 15 pouches of each composition were prepared. The bags are made of PE/PET laminated are thermally sealed; the bags have a micro-hole at the bottom for venting. The six bags were then placed in a humidity chamber at 80% RH and constant temperature of 32° C.

After 4, 8 and 12 weeks, one bag for each composition is opened and three pouches are taken out and analysed for amylase and protease activity. The activity is determined using colorimetric substrates sensitive to each enzyme.

The results obtained were the following:

| | Composition 1 | | Composition 2 | |
|---|---|---|---|---|
| | Protease | Amylase | Protease | Amylase |
| | mg active per 100 g product (% target) | | | |
| Initial | 236.35 (118%) | 21.35 (121%) | 195.90 (85%) | 32.52 (121%) |
| 4 weeks | 182.22 (91%) | 20.63 (116%) | 248.56 (108%) | 31.47 (116%) |
| 8 weeks | 114.27 (57%) | 18.44 (104%) | 191.17 (83%) | 32.00 (118%) |
| 12 weeks | 81.80 (41%) | 7.59 (43%) | 211.21 (92%) | 33.98 (126%) |

The tabulated results show that contrary to what it was expected moisture sensitive ingredients (protease and amylase) are more stable in a composition comprising a MGDA hygroscopic particle (Trilon M SG) than in a composition comprising phosphate.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A moisture-permeable detergent pack comprising a plurality of water-soluble unit-dose detergent products the products comprising a phosphate-free detergent composition and an enveloping material the detergent composition comprising:
a) a moisture sensitive ingredient; and
b) from 15% to 50% by weight of the product of an aminocarboxylic complexing agent wherein the aminocarboxylic complexing agent is in the form of a hygroscopic particle.

2. The detergent pack according to claim 1 wherein the hygroscopic particle can pick up at least 1% of its weight at 32° C. and 80% relative humidity in less than 150 minutes.

3. The detergent pack according to claim 1 wherein the hygroscopic particle can pick up at least 10% of its weight at 32° C. and 80% relative humidity in less than 24 hours.

4. The detergent pack according to claim 1 wherein the hygroscopic particle can pick up at least 50% of its own weight at 32° C. and 80% relative humidity when left to equilibrate.

5. The detergent pack according to claim 1 wherein the aminocarboxylic complexing agent is selected from the group consisting of methyl glycine diacetic acid, its salts and derivatives thereof, glutamic-N,N-diacetic acid, its salts and derivatives thereof and mixtures thereof.

6. The detergent pack according to claim 1 wherein the hygroscopic particle comprises:
a) from 20 to 95% by weight of the particle of aminocarboxylic acid, preferably a salt of methyl glycine diacetic acid;
b) from 5 to 80% by weight of the particle of material selected from the group consisting of:
i) polyalkylene glycol, preferably polyethylene glycol
ii) nonionic surfactant;
iii) a polymer selected from the group consisting of polyvinyl alcohols, polyvinylpyrrolidones (PVP), and
iv) a mixture thereof.

7. The detergent pack according to claim 1 wherein the hygroscopic particle is obtainable by dissolving components (a) and (b) in a solvent and spray-drying the resulting mixture and optionally followed by a granulation step.

8. The detergent pack according to claim 1 wherein the hygroscopic particle has a particle size of from about 600 to about 1000 μm.

9. The detergent pack according to claim 1 wherein the moisture sensitive ingredient is selected from the group consisting of enzymes, bleach and mixtures thereof.

10. The detergent pack according to claim 1 wherein the enzymes are selected from the group consisting of amylases, proteases and mixtures thereof.

11. The detergent pack according to claim 1 wherein the composition is alkaline.

12. The detergent pack according to claim 1 wherein the composition further comprises a dispersant polymer.

13. The detergent pack according to claim 1 wherein the enveloping material is a water-soluble polyvinyl alcohol based film having a thickness of less than 100 μm.

14. The detergent pack according to claim 1 wherein the composition is a particulate composition.

15. Use of an aminocarboxylic complexing agent in the form of a hygroscopic particle to improve the chemical stability of a phosphate-free automatic dishwashing detergent composition.
